(19) United States
(12) Patent Application Publication
(10) Pub. No.: US 2009/0247719 A1
(43) Pub. Date: Oct. 1, 2009

(54) PROCESS FOR CHLOROSULFONATING POLYOLEFINS

(75) Inventor: Royce E. Ennis, Silsbee, TX (US)

Correspondence Address: DUPONT PERFORMANCE ELASTOMERS L.L.C., PATENT RECORDS CENTER, 4417 LANCASTER PIKE, BARLEY MILL PLAZA P25, WILMINGTON, DE, 19805, US

(73) Assignee: DuPont Performance Elastomers L.L.C.

(21) Appl. No.: 12/401,844

(22) Filed: Mar. 11, 2009

Related U.S. Application Data
(60) Provisional application No. 61/072,505, filed on Mar. 31, 2008.

(51) Int. Cl. C08F 210/00

(52) U.S. Cl. 526/348

(57) ABSTRACT

Chlorosulfonated polyolefin elastomers containing 1-10 weight percent chlorine and 0.5 to 5 weight percent sulfur and having with a Cl:S weight ratio of 10 or less are prepared in a batch solution process employing a chlorosulfonation agent of sulfuryl chloride or the combination of Cl₂ and SO₂.

### CROSS-REFERENCE TO RELATED APPLICATIONS

This application claims the benefit of U.S. Provisional Application No. 61/072,505 filed Mar. 31, 2008.

### FIELD OF THE INVENTION

This invention relates to a process for chlorosulfonating polyolefins, more particularly to a process for manufacturing chlorosulfonated polyolefins comprising 1 to 10 weight percent chlorine and 0.5 to 5 weight percent sulfur and having a weight ratio of chlorine to sulfur of 10 or less.

### BACKGROUND OF THE INVENTION

Chlorosulfonated polyethylene elastomers and chlorosulfonated ethylene copolymer elastomers have been found to be very good elastomeric materials for use in applications such as wire and cable jacketing, molded goods, automotive hose, power transmission belts, roofing membranes and tank liners. These materials are noted for their balance of oil resistance, thermal stability, ozone resistance and chemical resistance.

Historically, a wide variety of polyolefin polymers, including ethylene and propylene homopolymers and copolymers, have been utilized as the starting polymers (i.e. “base polymers” or “base resins”) for manufacture of chlorosulfonated products. The majority of base polymers employed in the manufacture of chlorosulfonated elastomers have been polyethylene types, e.g. low density polyethylene (LDPE), linear low density polyethylene (LLDPE) and high density polyethylene (HDPE). Most of the ethylene homopolymers and copolymers employed to make these elastomers are polymerized by a high pressure free radical catalyzed process or by a low pressure process using Ziegler-Natta or Phillips type catalysts. Recently, LLDPE made by single site or metallocene catalysts have become readily available.

Most commercial chlorosulfonated polyolefins contain between 20 and 50 weight percent chlorine and between 0.5 and 1.5 weight percent sulfur and have Cl:S weight ratios between 20 and 45, typically 30 to 35. They are generally made in a high temperature (i.e. >110° C.) process. These high chlorine levels are normally required to achieve the desired oil resistance for various applications and the sulfur level to achieve desired cure rates and final elastomeric vulcanizate physical properties.

Ethylene based elastomers (e.g. EP and EPDM) are utilized as viscosity modifiers for oils in automotive and industrial applications. These polymers are readily soluble and stable in paraffinic and napthenic oils whereas more polar polymers (e.g. ethylene acrylic or methacrylic copolymers and highly chlorinated ethylene polymers) are not. Some of these oil additive polymers are also functionalized with reactive groups in order to incorporate stabilizers for formulated oil systems having enhanced stability.

Isobutylene based elastomers (e.g. PIB and isobutylene/diene copolymers) have traditionally been used as modifying agents for motor oils and greases to enhance their utility at higher temperatures.

Styrene based elastomers (e.g. SBS and SIS block copolymers and preferably their hydrogenated derivatives) have also shown utility as viscosity modifiers in oil formulations and in adhesive applications.

Propylene based polymers (e.g. atactic polypropylene and propylene/ethylene copolymers) have been employed as adhesives and bonding agents as well as viscosity modifiers in industrial applications.

Many of these polymers are functionalized, via grafting techniques, with reactive groups (e.g. maleic anhydride) in order to incorporate stabilizers for oil-based formulations. These modified functionalized polymers enhance oil stability and prevent deposit formation in equipment.

It would be desirable to have chlorosulfonated polyolefins having less than 10 weight percent chlorine and a low level of residual crystallinity for use in oil based solutions. In some of the end use applications where solution viscosity must be balanced with oil solubility and polymer thermal stability, it would be desirable to employ copolymers manufactured with a single site catalyst to alleviate the low level of highly crystalline material normally present in traditional LLDPE materials.

It would be desirable to have chlorosulfonated polyolefins that contain 1 to 10 weight percent (wt. %) chlorine and 0.5 to 5 wt. % sulfur and have a Cl:S weight ratio of 10 or less to take advantage of the chlorosulfonated polyolefins' oil solubility and reactive sulfonyl chloride groups in these special end use applications. Such polymers have been made (U.S. Pat. No. 3,624,054, U.S. Pat. No. 4,560,731 and EP 131948 A2) by gas phase processes. However, these chlorosulfonation processes suffer from the disadvantage of requiring base polymers that have high levels of crystallinity.

In order to chlorosulfonate an amorphous or low crystallinity base polyolefin, it has been necessary to utilize a low temperature solution phase process for the manufacture of these low chlorine, high sulfur chlorosulfonated polyolefins (U.S. Published Patent Applications 20080249243 A1 and 20080249254 A1). Such a process allows the production of chlorosulfonated products having low or no crystallinity and having the combination of low chlorine and moderate to high sulfur levels that are not generally obtainable via a conventional high temperature solution phase chlorosulfonation process. However, this low temperature process has several disadvantages. First the base resins must be amorphous or have very low levels of crystallinity to remain soluble in the solvent systems during the required low temperature chlorosulfonation process (<75° C., preferably <65° C.). Also during this process, high levels of chlorosulfonation agents (e.g. Cl₂, SO₂ and/or SO₂Cl₂) are continuously added to the reactor while excess chlorosulfonation agents are continuously swept from the reaction zone, along with byproducts of the reaction (e.g. HCl). This “off gassing” effluent stream must undergo extensive neutralization and/or recycling efforts, which are costly.

It would be desirable to have a chlorosulfonation process that would allow the preparation of chlorosulfonated polyolefins having 1 to 10 weight percent chlorine and 0.5 to 5 weight percent sulfur and a Cl:S weight ratio of 10 or less while minimizing the requirements for neutralization and recycling of off-gasses.

### SUMMARY OF THE INVENTION

An aspect of the present invention is a batch reactor process for the manufacture of chlorosulfonated polyolefins comprising 1 to 10 weight percent chlorine and 0.5 to 5 weight percent sulfur and having a weight ratio of chlorine to sulfur of 10 or less, said process comprising:

A) dissolving at least one polyolefin base polymer in a solvent at a temperature between 50° and 110° C. to form a solution in a reactor;

B) adjusting the temperature of said solution to between 75° and 100° C. without precipitating said polyolefin;

C) adding a chlorosulfonation agent to said reactor;

D) adding an initiator to said solution after said chlorosulfonation agent has been added; and

E) maintaining said temperature between 75° and 100° C., while retaining all gases within said reactor, to form at least one chlorosulfonated polyolefin comprising 1 to 10 weight percent chlorine and 0.5 to 5 weight percent sulfur and having a weight ratio of chlorine to sulfur of 10 or less.

### DETAILED DESCRIPTION OF THE INVENTION

The chlorosulfonated polyolefins made by the process of this invention contain between 1 and 10 (preferably between 1 and 8, most preferably between 1 and 6) weight percent (wt. %) chlorine and between 0.5 and 5 (preferably between 0.5 and 3, most preferably between 0.5 and 2) weight percent sulfur and have a weight ratio of chlorine to sulfur (Cl:S) of 10 or less (preferably 9 or less, most preferably 8 or less). These copolymers are made in a solution process (meaning that the polyolefin base polymer is dissolved in a solvent) by reaction with a chlorosulfonation agent selected from the group consisting of i) Cl₂ and SO₂ and ii) sulfuryl chloride (SO₂Cl₂). The process of this invention is referred to as a “closed” or “batch” chlorosulfonation process. It is characterized by 1) no “off-gassing” during the chlorosulfonation process and by 2) all reactants being introduced into the reactor before any free radical initiator is added to the reactor system.

In the Cl₂/SO₂ chlorosulfonation process, a solvent mixture of carbon tetrachloride and chloroform is introduced to a reactor having a condenser, pressure control and safety release system. Next, a quantity of polyolefin base polymer is added to the reactor. Optionally, more than one polyolefin base polymer may be added to the reactor so as to result in a blend of chlorosulfonated polyolefin polymers. For some end use applications, a blend of 2 or more different (e.g. different comonomers, different molecular weight distributions, etc.) chlorosulfonated polymers may be preferable. Any moisture in the reactor may optionally be removed by either 1) pulling a vacuum on the reactor, thus flashing an azeotrope of solvent and water from the reactor, or 2) addition of a small amount of a chemical moisture scavenger (e.g. thionyl chloride or acetyl chloride). The reactor is optionally purged with an inert gas (e.g. nitrogen) to remove oxygen, closed and then the pressure control system is engaged at the safety relief set point.

The solution in the reactor is heated to about 50° to 110° C. (preferably 55° to 100° C.) to dissolve all of the polyolefin base polymer. The temperature of the solution is then adjusted to approximately the desired reaction temperature between 50° and 110° C. (preferably 75° to 100° C.), without precipitating the polyolefin base polymer. Next, a desired amount of chlorine gas and sulfur dioxide is introduced into the reactor.

Alternatively, the chlorosulfonation agent, in this case chlorine gas and sulfur dioxide, and/or other ingredients may be added to the reactor prior to adjusting the temperature of the solution to the desired reaction temperature. After all reactants have been introduced into the reactor and the temperature adjusted to the desired reaction temperature, an azo initiator (e.g. Vazo® 64 available from DuPont) is introduced to the reactor to begin the chlorosulfonation process. There is no “off gassing” from the reactor during the chlorosulfonation reaction until the reaction end point has been reached and the resulting chlorosulfonated polyolefin product is recovered. When a desired level of chlorosulfonation has occurred, the reactor pressure is released and the reaction mass is degassed by application of a vacuum. Optionally, nitrogen gas may be introduced to the reactor prior to application of the vacuum. Optionally, an epoxide, e.g. Epon® 828 (available from Hexion Specialty Chemicals), is added to stabilize the product. Also optionally, an antioxidant, e.g. Irganox® 1010 (available from Ciba Specialty Chemicals) is added to protect the polymer during isolation and storage.

The SO₂Cl₂ chlorosulfonation process differs from the Cl₂/SO₂ process in that sulfuryl chloride and an optional amine activator (e.g. pyridine, 1,8-diazabicyclo[5.4.0]undec-7-ene (DBU), etc.), rather than chlorine gas and sulfur dioxide, is employed to chlorosulfonate the polyolefin base polymer. Optionally, additional SO₂ may be utilized along with the SO₂Cl₂.

A combination of the two chlorosulfonation processes can also be utilized in this invention, i.e. all three components (Cl₂, SO₂ and SO₂Cl₂) may be employed in the chlorosulfonation process of the invention.

The polyolefin elastomers employed as base resins to make the chlorosulfonated polyolefins by the process of the invention are selected from the group consisting of ethylene/alpha-olefin copolymers, ethylene/propylene/diene copolymers, propylene/ethylene copolymers, isobutylene/diene copolymers, isobutylene homopolymers, hydrogenated styrene/butadiene block copolymers and hydrogenated styrene/isoprene block copolymers. These copolymers may be semi-crystalline or amorphous.

Specific commercially available examples of these polyolefin elastomers include, but are not limited to Tafmer® copolymers (ethylene/propylene, ethylene/butene, ethylene/octene copolymers) available from Mitsui Chemicals; Versify® Plastomer and Elastomers (propylene/ethylene copolymers), Nordel® EPDM (ethylene/propylene/diene copolymers), Affinity® or Engage® (ethylene/alpha-olefin copolymers) available from The Dow Chemical Company; Vistamaxx® specialty elastomers (propylene/ethylene copolymers), Vistalon® EPDM (ethylene/propylene/diene copolymers), Vistalon® EPM (ethylene/propylene copolymers), Exxon Butyl® (isobutylene/diene copolymers) and Vistanex® PIB (isobutylene homopolymers), available from ExxonMobil; and Kraton® G SEBS (hydrogenated styrene/butadiene block copolymers) & SEPS (hydrogenated styrene/isoprene block copolymers) from The Kraton company.

The ethylene based polymers employed in the process of this invention include various ethylene/alpha-olefin copolymers. This includes traditional Ziegler-Natta LLDPE and single site or metallocene derived ethylene alpha-olefin copolymers. The alpha-olefin may be any unbranched alpha-olefin containing between 3 and 20 carbon atoms. Octene-1, butene-1 and propylene are preferred alpha-olefins. The copolymers may be semi-crystalline or amorphous. Semi-crystalline copolymers are preferred because they are easier to handle.

Chlorosulfonated polyolefins made by the process of the invention may be compounded with curatives and other additives typically employed in chlorosulfonated polyolefin compositions.

Chlorosulfonated polyolefins made by the process of this invention may also be converted to sulfonate derivatives for use in other end use applications.

Useful curatives include bismaleimide, peroxides (e.g. Di-Cup®), sulfur donors (e.g. dithiocarbamyl polysufides) and metal oxides (e.g. MgO).

Examples of additives suitable for use in the compositions include, but are not limited to i) fillers; ii) plasticizers; iii) process aids; iv) acid acceptors; v) antioxidants; and vi) antiozonants.

### EXAMPLES

### Test Methods

Weight percent Cl and S incorporated in chlorosulfonated copolymers was measured by the Schoniger combustion method (J. C. Torr and G. J. Kallos, American Industrial Association J. July, 419 (1974) and A. M. MacDonald, Analyst, v86, 1018 (1961)).

### Comparative Example A

A chlorosulfonated ethylene/propylene copolymer was prepared by a chlorine gas/SO₂ chlorosulfonation process of the prior art wherein off-gassing from the reactor occurred during the reaction. The resulting copolymer contained only 0.21 wt. % S and had a Cl:S weight ratio of 13.1.

40 pounds (18.2 kg) of solvent consisting of 92 wt. % carbon tetrachloride and 8 wt. % chloroform was added to a 10 gallon (38 L) jacketed reaction vessel fitted with an agitator, a condenser and a pressure control and safety relief system. 1,226 grams of an ethylene/propylene polymer (Tafmer® P0080K, available from Mitsui Chemicals, Inc., having a melt flow rate @230° C. of 40 g/10 minute (min.) and a density of 0.870 g/cubic centimeter (cc)) and 136 g of an ethylene/propylene copolymer (Tafmer® P 0680, available from Mitsui Chemicals, Inc., having a melt flow rate @ 230° C. of 0.5 g/10 min. and a density of 0.870 g/cc) was added to the reactor. The reaction vessel was sparged with nitrogen at 10 liters/minute, atmospheric pressure, for approximately 20 minutes (with agitation) to remove air. After sparging, the nitrogen flow was stopped and the reactor safety relief/off-gassing pressure controller was set at 20 psig (138 kPa). The reactor was heated with jacket steam to 85° C. and maintained at that temperature for 30 minutes (with agitation) to completely dissolve the polymer. The reactor pressure was increased by 2 psig (13.8 kPa) with sulfur dioxide (from 2 psig (13.8 kPa) to 4 psig (27.6 kPa)) and then with N₂ to 20 psig (138 kPa). While maintaining reactor temperature at 85° C. throughout the reaction, a flow of a 0.7 wt. % solution of Vazo® 52 initiator in chloroform was started and added at a rate of 200 ml/hour throughout the reaction. After ten minutes of initiator addition, chlorine gas was then sparged into the reactor at a rate of 100 g per hour and sulfur dioxide addition was continued at 200 g/hour until a total of 50 g of chlorine gas had been added. During the period of the chlorosulfonation reaction an “off gassing” of vapors occurred and was directed into a neutralization vessel. A small sample of the reaction solution was taken and the chlorosulfonated polymer was isolated and dried. The product was found to contain 2.76 wt. % chlorine and 0.21 wt. % sulfur. The reactor pressure was reduced to atmospheric pressure in order to partially remove dissolved gaseous byproducts. Sparging with nitrogen gas at a rate of 10 liters/minute was conducted for 15 minutes to further remove byproducts. The reaction mass was then stabilized by addition of 10 g of Epon® 828.

### Comparative Example B

Another chlorosulfonated polyolefin sample was made using the same base resins and procedure as in Comparative Example A. The reactor contents were maintained at 85° C. for 30 minutes in order to rapidly dissolve the polymer and then the temperature was lowered to 75° C. and was maintained at 75° C. throughout the chlorosulfonation reaction. Again during the time of the chlorosulfonation reaction an “off gassing” of vapors occurred and was directed into a neutralization vessel. A small sample of the reaction solution was taken and the chlorosulfonated polymer isolated and dried. The product was found to contain 3.5 wt. % chlorine and 0.48 wt. % sulfur, i.e. outside of the limits of the invention, and had a Cl:S weight ratio of 7.92.

### Example 1

55 pounds (24.95 kg) of ambient temperature solvent consisting of 90 wt. % carbon tetrachloride and 10 wt. % chloroform was added to a ten gallon (38 L) reactor fitted with an agitator, a condenser and a pressure control and safety relief system. 952 g of an ethylene/propylene copolymer (Tafmer® P0080K, available from Mitsui Chemicals, Inc., having a melt flow rate @230° C. of 40 g/10 minute (min.) and a density of 0.870 g/cc) and 410 g of an ethylene/propylene copolymer (Tafmer® P 0680, available from Mitsui Chemicals, Inc., having a melt flow rate @ 230° C. of 0.5 g/10 min. and a density of 0.870 g/cc) was added to the reactor. The reactor vessel was closed, the safety relief/off-gassing pressure control set at 40 psig (275 kPa) and the reactor heated to 75° C. with stirring for 15 minutes to ensure that the polymer was dissolved. Gaseous sulfur dioxide was then added at a rate of 600 g/hour (g/h) until the reactor pressure had increased by 10 psig (69 kPa) (from approximately 1 psig (6.9 kPa) to 11 psig (75.8 kPa)). The reactor was then heated to 93° C. After the temperature stabilized, additional sulfur dioxide was added until the reactor pressure reached 25 psig (172 kPa). Total sulfur dioxide added was 187 grams. Chlorine gas was then added at a rate of 110 g/h until 81 g of chlorine had been added (43 minutes). No “off gassing” of SO₂ or Cl₂ occurred during this addition. After all Cl₂ and SO₂ had been added and the temperature stabilized, a flow of a 0.7 wt. % solution of Vazo® 64 initiator in chloroform was started and was added at a rate of 200 ml/h for 24 minutes while maintaining the reactor temperature at 90°-93° C. The reactor pressure peaked at 30 psig (207 kPa) during the chlorosulfonation reaction. No “off gassing” occurred during this period of time. A sample of the reactor contents was taken for analysis. The product contained 2.5 wt. % combined chlorine and 1.23 wt. % sulfur. The reactor pressure was then reduced to atmospheric to remove excess sulfur dioxide and byproduct hydrogen chloride. 12 g of Epon® 828 was dissolved in 20 ml of chloroform and then added to the reactor for polymer stabilization. The product was isolated from the solvent by drum drying. The product had a Cl:S weight ratio of 2.03.

### Example 2

50 pounds (22.68 kg) of ambient temperature solvent consisting of 90 wt. % carbon tetrachloride and 10 wt. % chloroform was added to a ten gallon (38 L) reactor fitted with an agitator, a condenser and a pressure control and safety relief system. 1362 g of an ethylene/propylene copolymer (Tafmer® P0080K, available from Mitsui Chemicals, Inc., having a melt flow rate @230° C. of 40 g/10 min. was added. The reactor was closed and the safety relief/off-gassing pressure control set at 40 psig (275 kPa). The reaction mass was heated, with stirring, to 87° C. and sulfur dioxide was added intermittently at a rate of 600 g/h until the reactor pressure reached 20 psig (137 kPa). A total of 180 g of sulfur dioxide was added. Chlorine gas was then added at a rate of 160 g/h until 80 g had been added. No “off gassing” occurred during the addition of the chlorine gas. After all the SO₂ and Cl₂ was added to the system and the temperature stabilized, a flow of a 0.7 wt. % solution of Vazo® 64 initiator in chloroform was started and was added at a rate of 200 ml/h for approximately 25 minutes while maintaining the reactor temperature at 85°-86° C. The reactor pressure peaked at 22 psig (152 kPa) during the chlorosulfonation reaction. A sample of the reactor contents was taken for analysis. The product contained 3.8 wt. % combined chlorine and 1.57 wt. % sulfur. The reactor pressure was then reduced to atmospheric to remove excess sulfur dioxide and byproduct hydrogen chloride. 12 g of Epon® 828 was dissolved in 20 ml of chloroform and added to the reactor for polymer stabilization. The product was isolated from the solvent by drum drying. The product had a Cl:S weight ratio of 2.42.

### Example 3

40 pounds (18.14 kg) of an ambient temperature solvent consisting of 90 wt. % carbon tetrachloride and 10 wt. % chloroform was added to a ten-gallon (38L) jacketed reaction vessel fitted with a condenser and a pressure control and safety relief system. 3.0 pounds (1362 g) of an ethylene/propylene copolymer (Vistalon® 878 pellets having a melt index of 6.5 g/10 min. @190° C./21.6 kg) available from the Exxon-Mobil Company was added to the reactor. The reactor contents were saturated with sulfur dioxide by sparging sulfur dioxide through a dip tube at 200 g/h for one hour at atmospheric pressure. 3 ml of DBU (1,8-diazabicyclo[5.4.0]undec-7-ene) dissolved in 50 ml of CCl₄ was added, the reactor closed and the safety relief/off-gassing pressure control set at 40 psig (275 kPa). The reactor pressure was increased to 20 psig (138 kPa) with nitrogen. The reactor contents were heated to 92° C. with steam on the jacket. After allowing 15 minutes to completely dissolve the polymer, 150 ml of sulfuryl chloride was added at 30 ml/min. through a line. The line was then flushed with CCl₄ to sweep all of the sulfuryl chloride into the reactor. No additional nitrogen or sulfur dioxide was added. While maintaining the reactor temperature at 92° C., a 1 wt. % solution of Vazo® 64 was added at a rate of 3.33 ml/min. for 25 minutes. The reactor pressure increased to 26 psig (179 kPa) and the reactor temperature increased to 94° C., indicating reaction. The reactor pressure leveled off at 26 psig (179 kPa) and the temperature dropped to 93° C. indicating that the reaction was complete. No “off-gassing” occurred during the chlorosulfonation reaction. A reactor sample was taken and was found to contain no residual sulfuryl chloride by FTIR analysis. After isolating from the solvent, the reactor polymer sample was found to contain 3.0 wt. % chlorine and 1.31 wt. % sulfur. The reactor pressure was reduced to atmospheric to remove dissolved sulfur dioxide and hydrogen chloride byproduct gasses. 12 g of Epon® 828 and 0.9 grams of Irganox® 1010 was added to stabilize the polymer. The polymer was isolated from the solvent by drum drying. The product had a Cl:S weight ratio of 2.29.

### Example 4

40 pounds (18.14 kg) of an ambient temperature solvent consisting of 90 wt. % carbon tetrachloride and 10 wt. % chloroform was added to a ten gallon (38L) jacketed reaction vessel fitted with a condenser and pressure control system. 3.0 pounds (1362 g) of a propylene/ethylene copolymer (Vistamaxx® 1100, available from ExxonMobil Chemical Corporation, having a MFR of 3 (ASTM D-1238, g/10 min. @230° C., 2.16 kg) and density of 0.860 g/cm³) was then added to the reactor and the reactor closed and the safety relief/off-gassing pressure control set at 40 psig (275 kPa). The reactor contents were heated with jacket steam to 95° C., over a 30 minute period while adding sulfur dioxide at 200 g/h. Also during this period, 150 ml of sulfuryl chloride were added at 30 ml/min. Sulfur dioxide flow rate was continued at 200 g/h until a total of 250 grams of sulfur dioxide had been added. The reactor temperature was maintained at 95° C. during these additions. After all additions were completed, the reactor contents were stirred an additional 5 minutes to assure complete polymer dissolution.

Separately, 3 ml of DBU and 2 g of Vazo® 64 were dissolved in 100 cc's of chloroform.

While maintaining the reactor temperature at 95° C., a flow of the chloroform solution of DBU and Vazo® 64 was added at a rate of 5 ml/min. for 20 minutes. During this time the reactor pressure increased to 29.3 psig (202 kPa) and leveled off, indicating the reaction was complete. No “off-gassing” occurred during this chlorosulfonation reaction. A sample of the reactor contents showed no residual sulfuryl chloride remaining and when a polymer sample was isolated from this sample, it was found to contain 4.21 wt. % chlorine and 1.62 wt. % sulfur. The reaction mass was 5 degassed by decreasing the pressure to atmospheric. 12 g of Epon® 828 and 0.9 g of Irganox® 1010 was added as stabilizers. The reacted solution was isolated by drum drying and set aside. The product had a Cl:S weight ratio of 2.60.

### Example 5

Chlorosulfonated EPDM (Nordel® 4725P available from The Dow Chemical Co., having a Mooney viscosity (ML 1+4 @125° C.) of 25 and a density of 0.88 g/cc) was prepared using the sulfuryl chloride chlorosulfonation process of the invention. The procedure was the same as that of Example 3, except that 300 ml of sulfuryl chloride, 300 g of sulfur dioxide and 4 ml of DBU were used. The pressure increase was from 20 psig (138 kPa) to 26.5 psig (183 kPa) during the chlorosulfonation reaction and no “off-gassing” occurred during this chlorosulfonation reaction. After 25 minutes, a sample of the reactor contents was taken and found to contain 6.9 wt. % chlorine and 1.29 wt. % sulfur. The reaction mass was degassed by reducing the pressure to atmospheric. The polymer was stabilized by addition of 12 g of Epon® 828. The product had a Cl:S weight ratio of 5.35.

### Example 6

Chlorosulfonated butyl rubber (Butyl 165 available from Exxon Chemical Co. having Mooney Viscosity (ML 1+4@125° C.) of 32 and density of 0.92 g/cm³) was prepared following the procedure and quantities of Example # 4. The pressure increased to approximately 28 psig (193 kPa) during the chlorosulfonation reaction and no “off-gassing” occurred during this chlorosulfonation reaction. After approximately 25 minutes, a sample of the reactor contents was taken and found to contain 3.4 wt. % chlorine and 1.2 wt. % sulfur. The reaction mass was degassed by reducing the pressure to atmospheric. The polymer was stabilized by addition of 12 g of Epon® 828. The product had a Cl:S weight ratio of 2.83.

What is claimed is:

1. A batch reactor process for the manufacture of chlorosulfonated polyolefins comprising 1 to 10 weight percent chlorine and 0.5 to 5 weight percent sulfur and having a weight ratio of chlorine to sulfur of 10 or less, said process comprising:
A) dissolving at least one polyolefin base polymer in a solvent at a temperature between 50° and 110° C. to form a solution in a reactor;
B) adjusting the temperature of said solution to between 75° and 100° C. without precipitating said polyolefin;
C) adding a chlorosulfonation agent to said reactor;
D) adding an initiator to said solution after said chlorosulfonation agent has been added; and
E) maintaining said temperature between 75° and 100° C., while retaining all gases within said reactor, to form at least one chlorosulfonated polyolefin comprising 1 to 10 weight percent chlorine and 0.5 to 5 weight percent sulfur and having a weight ratio of chlorine to sulfur of 10 or less.

2. A process of claim 1 wherein said chlorosulfonation agent comprises chlorine gas and sulfur dioxide.

3. A process of claim 2 wherein said chlorosulfonation agent further comprises sulfuryl chloride.

4. A process of claim 1 wherein said chlorosulfonation agent comprises sulfuryl chloride.

5. A process of claim 4 wherein said chlorosulfonation agent further comprises sulfur dioxide.

6. A process of claim 1 wherein said polyolefin base polymer is a copolymer of ethylene and a C₃ to C₂₀ unbranched alpha-olefin.

7. A process of claim 6 wherein said alpha-olefin is selected from the group consisting of octene-1, butene-1 and propylene.

8. A process of claim 7 wherein said alpha-olefin is octene-1.

9. A process of claim 7 wherein said alpha-olefin is butene-1.

10. A process of claim 7 wherein said alpha-olefin is propylene.

11. A process of claim 1 further comprising the step of removing moisture from said solution prior to adding said chlorosulfonation agent and said initiator to said solution.

12. A process of claim 11 wherein said moisture removal is by pulling a vacuum on said reactor.

13. A process of claim 11 wherein said moisture removal is by addition of a chemical moisture scavenger to said solution.

14. A process of claim 1 wherein at least two different polyolefin base polymers are dissolved in A).

15. A process of claim 1 wherein said chlorosulfonated polyolefin is made from a polyolefin selected from the group consisting of copolymers of ethylene and a C₃-C₂₀ alpha olefin, propylene/ethylene copolymers, ethylene/propylene/diene copolymers, isobutylene/diene copolymers, isobutylene homopolymers, hydrogenated styrene/butadiene block copolymers and hydrogenated styrene/isoprene block copolymers.

16. A process of claim 15 wherein said polyolefin is an ethylene/propylene/diene copolymer.

17. A process of claim 15 wherein said polyolefin is an isobutylene/diene copolymer.

18. A process of claim 15 wherein said polyolefin is a propylene/ethylene copolymer.
